(19) United States
(12) Patent Application Publication
(10) Pub. No.: US 2008/0213625 A1
(43) Pub. Date: Sep. 4, 2008

(54) Optical Data Storage and Retrieval Based on Fluorescent and Photochromic Components

(75) Inventors: Francisco M. Raymo, Coral Gables, FL (US); Massimiliano Tomasulo, Miami, FL (US)

Correspondence Address: CHRISTOPHER & WEISBERG, P.A., 200 EAST LAS OLAS BOULEVARD, SUITE 2040, FORT LAUDERDALE, FL, 33301, US

(73) Assignee: UNIVERSITY OF MIAMI, Miami, FL (US)

(21) Appl. No.: 11/910,650

(22) PCT Filed: Apr. 6, 2006
(86) PCT No.: PCT/US2006/013203

§ 371 Date: Oct. 4, 2007

Related U.S. Application Data
(60) Provisional application No. 60/669,222, filed on Apr. 7, 2005.

(51) Int. Cl. B32B 9/04; G11B 3/74

(52) U.S. Cl. 428/704; 369/94

(57) ABSTRACT

An optical storage medium 100 has a multilayer structure that includes a photochromic layer 110 having a thermally-stable photochromic compound, and a fluorescent layer 120 having a fluorescent compound. The photochromic compound is transformable between a first form and a second form. The fluorescent compound has an excitation wavelength centered in a region that is not substantially absorbed by the second form of the photochromic compound, and an emission wavelength that is absorbed by the first form and not absorbed by the second form.

### BACKGROUND OF THE INVENTION

1. Field of the Invention

The disclosure relates generally to optical data storage and, more specifically, to the use of photochromic and fluorescent components in high capacity optical memories.

2. Description of the Related Art

Present optical memories rely on multilayer structures to store large numbers of bits. Referring to FIGS. 1A and 1B, a compact disk (CD), for example, hold billions of bits in the form of microscopic features carved optically in a polycarbonate layer 14 along a two-dimensional spiral track 12. The patterned polycarbonate disk 14 is covered with a reflective aluminum coating 16 and a protective polyacrylate film 18. The information inscribed along the spiral track 12 is read optically, while spinning the disk 10 around an orthogonal axis passing through its center. A timing mechanism ensures finite divisions of the moving track 12 to be illuminated individually by a laser source positioned below the polycarbonate layer 14. The frames centered in the “pits” and “bumps” of the aluminum coating 16 have even surfaces and correspond to binary 0's. Those frames centered at the edges of the indentations have uneven surfaces and correspond to binary 1's. The two sets of divisions can be distinguished by measuring the light reflected from their different surfaces back to a detector. In this manner, the entire digital information stored in the disk 10 along the spiral track 12 can be retrieved using this protocol.

The polycarbonate layer 14 interposed between the aluminum coating 16 and the light source must be transparent to the reading wavelength to allow the incident beam to reach the aluminum mirror 16. This limitation restricts the storage capacity of CDs to a single layer of pits and bumps. In an effort to enhance the volume of recordable information, semi-reflective overlayers have been introduced in digital versatile disks (DVDs). These media can have up to two storing and overlapping layers per disk face and, therefore, extend their capacity in the direction normal to the disk surface. Nonetheless, data storage in three dimensions cannot be implemented in full with this technology. As a result, a number of strategies for the development of three-dimensional optical storage media have been actively pursued in recent years.

Photochromic molecules have been investigated as candidates for use with high-capacity optical memories. The photochromic molecules have the ability to switch from colorless to colored forms in response to optical stimulations, and this switching ability can be used to store binary digits (i.e., 0 and 1). The stored information can be retrieved optically following diverse protocols. For example, the covalent attachment of a fluorescent label to a photochromic switch enables the written data to be read by measuring the emission intensity. This method, however, often requires a multi-step synthetic procedure for the integration of fluorescent and photochromic fragments into the same molecular skeleton.

### BRIEF SUMMARY OF THE INVENTION

Embodiments of the invention address deficiencies of the art in respect to storage devices and provide a novel and non-obvious optical storage device. The optical storage medium has a multilayer structure that includes a photochromic layer having a thermally-stable photochromic compound, and a fluorescent layer having a fluorescent compound. The photochromic compound is transformable between a first form and a second form. The fluorescent compound has an excitation wavelength centered in a region that is not substantially absorbed by the second form of the photochromic compound, and an emission wavelength that is absorbed by the first form and not absorbed by the second form.

In certain aspects of the optical storage medium, the excitation wavelength is centered in a region that is not substantially absorbed by the first form of the photochromic compound. The photochromic compound may be selected from the group consisting of azulenes, azobenzenes, stilbenes, fulgides, diarylethenes, and spiropyrans. Also, the first form of the photochromic compound may be merocyanine and the second form may be spiropyran. The fluorescent compound may be benzofurazan.

In other aspects of the invention, an optical storage reading/recording device for reading/recording data on an optical storage medium is provided. The optical storage reading/recording device includes a fluorescing light source emitting light having a first wavelength, a transforming light source emitting light having a second wavelength; and a detector sensitive to light having a third wavelength. A fluorescent layer of the optical storage medium emits light having the third wavelength upon exposure to the first wavelength. The photochromic layer of the optical storage device includes a photochromic compound transformable between a first form and a second form upon exposure to light having the second wavelength.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIGS. 1A and 1B are schematic illustrations, respectively, of a compact disk having a spiral track and a cross-section of a portion of the spiral track;

FIG. 2 is a perspective view of a multilayer optical storage device in accordance with the inventive arrangements;

FIG. 3 is a molecular diagram illustrating the reversible interconversion between spiropyran (SP) and merocyanine (ME);

FIG. 4 is graph illustrating the evolution of the visible absorption spectrum of a PnBMA film doped with spiropyran under continuous irradiation at 341 nm;

FIGS. 5A and 5B are graphs of the evolution of the visible absorbance of a PnBMA film doped with spiropyran respectively after continuous irradiation at 341 nm and subsequent storage in the dark;

FIGS. 5C and 5C are graphs of the evolution of the visible absorbance of a PEMA-PMMA film doped with spiropyran respectively after continuous irradiation at 341 nm and subsequent irradiation at 562 nm;

FIG. 6 is a graph of the influence of twenty consecutive irradiation steps at 4 minutes each with alternating wavelengths (341 nm and 562 nm) on the visible absorbance of a PnBMA film doped with spiropyran;

FIG. 7A is a molecular diagram of benzofurazan;

FIG. 7B are graphs showing the excitation and emission spectra of a PMMA film containing benzofurazan and absorption spectra of a PnBMA film doped with spiropyran before and after irradiation at 341 nm;

FIG. 8 is a graph showing the changes in fluorescence intensity for the optical storage device upon irradiation at 341 nm (ultraviolet) or 562 nm (visible) and storage in the dark; and

FIG. 9 is a graph showing a protocol for data storage using the data shown in FIG. 8.

### DETAILED DESCRIPTION OF THE INVENTION

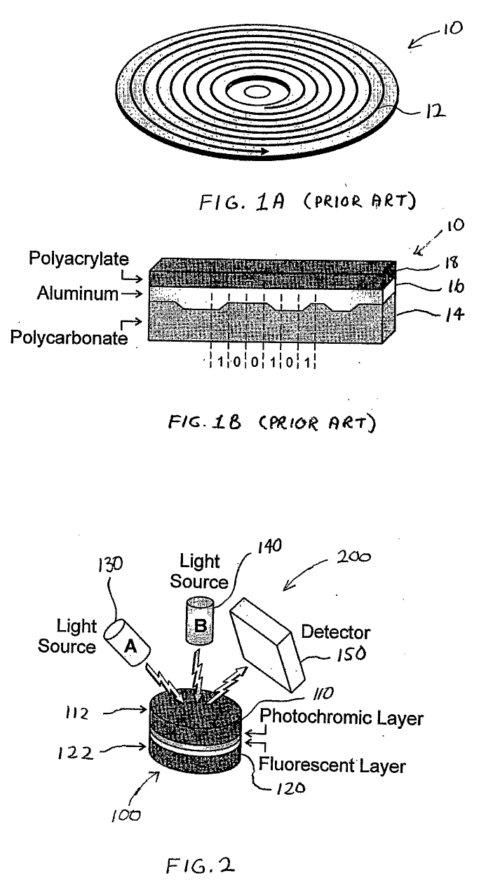

A optical storage device according to the invention is disclosed in FIG. 2. The optical storage device 200 includes an optical storage medium 100 having a multilayer structure including a photochromic layer 110 and a fluorescent layer 120. Unlike the conventional storage device 10 illustrated in FIG. 1, in which the incident and reflected beams share the same wavelength, in the present optical storage device 110, the wavelength of the beam leaving the first light source 130 and that of the beam traveling back to the detector 150 may be significantly different.

Although not limited in this manner, the optical storage medium 100 may be formed by respectively coating first and second substrates 112, 122, with the photochromic layer 110 and the fluorescent layer 120. The substrates 112, 122 can then be sandwiched together to form the optical storage medium 100.

The photochromic layer 110 includes a photochromic component. Photochromism is defined as a reversible transformation in a chemical species between two forms having different absorption spectra by irradiation, and thus, the photochromic component has two forms having different absorption spectra. As used herein, the photochromic component includes a first form and a second form. In the first form (also referred to as the colored state), the photochromic component substantially absorbs in a wavelength emitted by a fluorescent component of the fluorescent layer 120. In the second form (also referred to as the colorless state), the photochromic component does not substantially absorb in a wavelength emitted by the fluorescent component of the fluorescent layer 120.

As illustrated in FIG. 2, the first light source 130 may send a monochromatic beam through the first substrate 112 and photochromic layer 110 to the fluorescent layer 120. Although not limited to a particular wavelength, the monochromatic beam is selected so as to excite the fluorescent component of the fluorescent layer 120. The exciting light is absorbed at the fluorescent layer 120 and reemitted at longer wavelengths. When the photochromic component of the photochromic layer 110 is in the colorless state, the emission is not absorbed by the photochromic layer 110, and the emitted light travels back to the detector 150. When the photochromic component of the photochromic layer 110 is in the colored state, the emitted light is absorbed and blocked by the photochromic layer 110 before reaching the detector 150.

A second light source 140 is used to illuminate the photochromic layer 110 to induce the interconversion between the colorless and colored forms of the photochromic component of the photochromic layer. The colorless and colored form of the photochromic component may be selected so as to be transparent at the wavelength used to excite the fluorescent component. In this manner, the fluorescent layer 120 can be excited without affecting the photochromic component 130, whereas the photoinduced interconversion of the photochromic component of the photochromic layer 110 may be used to modulate the light emitted from the fluorescent layer 120.

A third light source may be included, which for purposes of discussion may be considered to be included within the second light source 140, although the optical storage device 200 is not limited in this manner. The third light source is used to illuminate the photochromic layer 110 to reverse the effect of the second light source 140. Thus, while the second light source 140 may induce interconversion from the colorless form to the colored form (or vice-versa), the third light source may induce interconversion from the colored form to the colorless form (or vice-versa).

If the photochromic component of the photochromic layer 110 is thermally stable, then the second light source 140 can write binary digits into the photochromic layer 110, where the bits will remain stored. The first light source 130, in combination with the detector 150, can then read the bits at any point in time thereby resulting in all-optical storage medium 100 in which data can be written, read and erased relying exclusively on optical signals. Examples of a thermally-stable photochromic compound include a diarylethene or a furylfulgide.

If the photochromic component of the photochromic layer 110 is thermally unstable, then the amplitude of the optical signal propagating from the first light source 130 to the detector 150 can be modulated by switching on and off the second light source 140. This result is an all-optical inverter in which an optical input from the second light source 140 gates an optical output from the first light source 130.

### Photochromic Component

The optical storage medium 100 is not limited in the manner in which the photochromic layer 110 is formed. In certain aspects, organic photochromes may be trapped in a rigid polymer matrices following, for example, evaporation or spin-coating procedures. The encaged dopants may retain their photochromic properties, and thin films of the resultant material may be deposited on a variety of supports/substrates.

Although not limited the following list, the photochromic component of the photochromic layer 110 may be selected from azulenes, azobenzenes, stilbenes, fulgides, diarylethenes and spiropyrans. For purposes of the following examples, studies were based on the reversible photoisomerization of spiropyrans. Referring to FIG. 3, spiropyran (SP) switches to the corresponding merocyanine (ME) upon ultraviolet irradiation. The colored isomer (merocyanine) reverts to the colorless form (spiropyran) in the dark or upon visible irradiation. Although the testing described below employed spiropyrans, the optical storage medium 100 is not limited in this manner, as any photochromic component may be used with the optical storage medium 100 provided that an optimal fluorescent partner in the fluorescent layer 120 can be identified.

### EXAMPLE

Referring to Table 1, following spin-coating procedures, the photochromic dopant of spiropyran was trapped within five different polymer films deposited on quartz plates. The amount of dopant in each polymer matrix is about 3.6% in weight relative to the polymer. The five polymer matrices are polymethylmethacrylate (PMMA), polystyrene (PS), polyethylmethacrylate-polymethylmethacrylate (PEMA-PMMA), poly-1-butylmethacrylate-poly-n-butylmethacrylate (PiBMA-PnBMA) and poly-n-butylmethacrylate (PnBMA). The photochromic layers 110 were prepared from dichloromethane solutions of spiropyran (3 mg mL-1) and one of the polymers (95 mg mL-1). Aliquots of these solutions were spin-coated on quartz plates at 480 rpm for 12 seconds.

Using surface profilometry, the thickness of the films was determined to range between about 2 and about 5 μm. Although the absorption spectra of these polymer films do not reveal significant absorbance in the visible region, the characteristic visible absorption band of merocyanine developed in all materials upon irradiation at a wavelength of 341 nm.

Tg is the glass transition temperature of the polymer matrix. The dipole moment of the polymer is represented by μ, and the values listed for the two copolymers PEMA-PMMA and PiBMA-PnBMA are the averages of the values of the constituent polymers. The wavelength of the visible absorption band of merocyanine is represented by λ. The absorbance raise constant for the photoinduced coloration (341 nm, 8 μW cm-2) is kUV, the absorbance decay constant for thermal decoloration is represented by kDark, and the absorbance decay constant for the photoinduced decoloration (562 nm, 320 μW cm-2) is represented by kVIS.

TABLE 1
Kinetic parameters associated with the interconversion
of spiropyran and merocyanine inside rigid polymer matrices

| | | μ | | kUV | kDark | kVIS |
|---|---|---|---|---|---|---|
| | Tg | (10−2 | λ | (10−4 | (10−4 | (10−4 |
| Matrix | (° C.) | D) | (nm) | s−1) | s−1) | s−1) |
| PMMA | 114 | 71 | 562 | 11 | 6 | 20 |
| PS | 100 | 10 | 585 | 56 | 16 | 49 |
| PEMA- | 48 | 73 | 561 | 50 | 10 | 35 |
| PMMA | | | | | | |
| PiBMA- | 35 | 73 | 560 | 65 | 23 | 51 |
| PnBMA | | | | | | |
| PnBMA | 15 | 78 | 560 | 169 | 77 | 115 |

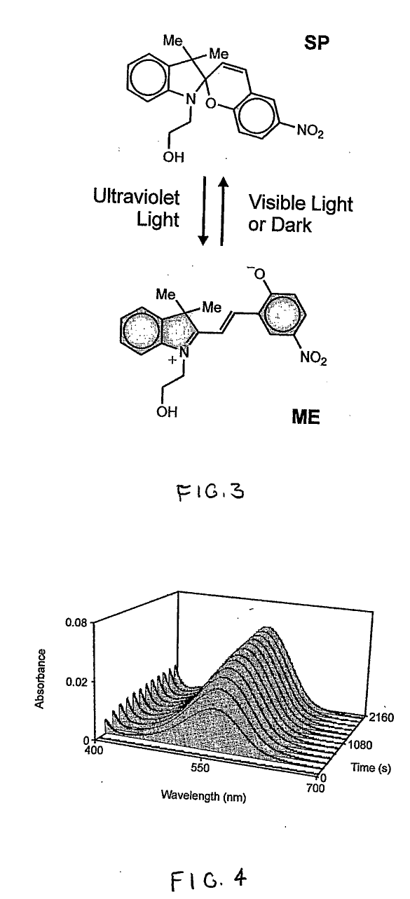

Referring to FIG. 4, a representative example of the evolution of the absorption spectrum of a doped PnBMA film is shown. In the four polyalkylmethacrylates of Table 1, the absorption band of merocyanine is centered at a wavelength (λ) of about 560 nm. In contrast, the absorption band of merocyanine appears at a λ of 585 nm in polystyrene (PS). This change may be a result of the difference in polarity between PS and the four polyalkylmethacrylates as literature data indicates the dipole moment (μ) to be only 0.1 D for PS and greater than 0.7 D for the four polyalkylmethacrylates.

Under continuous irradiation at 341 nm, the absorbance at λ increases exponentially with the irradiation time for all the doped polymers, and the absorbance decreases gradually when the light source is turned off or if the irradiation wavelength is changed to 562 nm. It is noted that all of the doped polymers retain a residual absorbance at λ after reaching thermal equilibrium. By contrast, the absorbance at λ is negligible at the photostationary state obtained after irradiation at 562 nm.

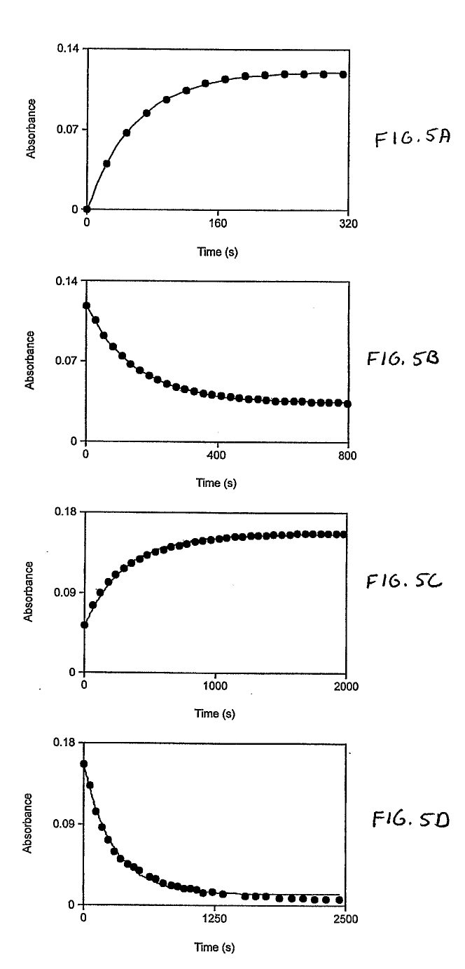

FIGS. 5A and 5B graphically illustrate the evolution of the visible absorbance of a PnBMA film doped with spiropyran. In FIG. 5A, the absorbance rises under continuous irradiation at 341 nm, and in FIG. 5B, the absorbance decays in the dark.

FIGS. 5C and 5D graphically illustrate the evolution of the visible absorbance of a PEMA-PMMA film doped with spiropyran. Similar to the PnBMA film, in FIG. 5C the absorbance for the PEMA-PMMA film rises under continuous irradiation at 341 nm, and in FIG. 5D, the absorbance decays upon irradiation at 562 nm (i.e., visible light).

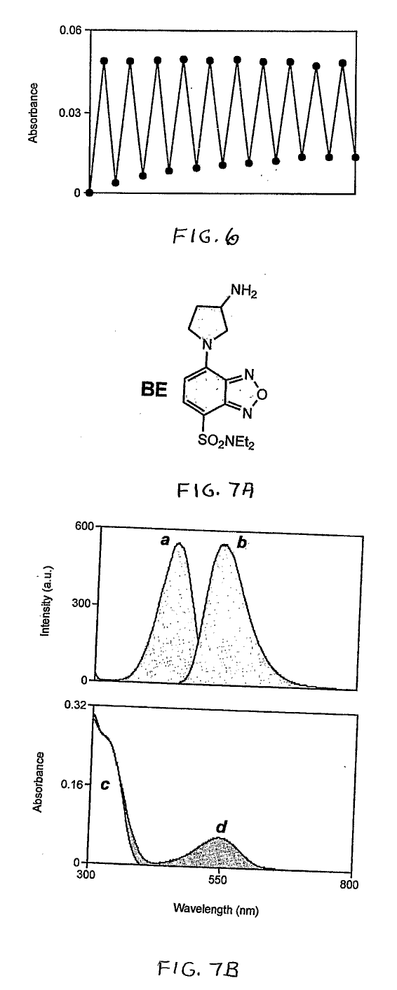

The absorbance at λ of either one of the above photochromic films can be modulated efficiently by switching the irradiation wavelength between ultraviolet and visible regions. FIG. 6 illustrates this effect for ten consecutive switching cycles of a doped PnBMA film. The absorbance, after irradiation at 341 nm (4 μW cm-2), is approximately constant for all steps. The absorbance, after irradiation at 562 nm (144 μW cm-2), increases almost linearly with the number of switching cycles, and this change may be attributed to the pronounced tendency of zwitterionic merocyanines to aggregate in nonpolar environments and delay their re-isomerization.

The absorbance changes for all coloration and decoloration steps fit respectively monoexponential raise and decay profiles. The associated raise (kUV) and decay (kDark and kVIS) constants for coloration are listed in Table 1. The coloration raise and decay constants decrease monotonically as the glass transition temperature (Tg) of the polymer matrix increases, with the exception of PS. The deviation of PS from this trend may be a result of its lower μ.

Referring to Table 2, the relative influence of the rigidity and polarity of the medium on the coloration and decoloration steps is further demonstrated from the values of kUV, kDark and kVIS determined in four solvents. The initial concentration of spiropyran in each solvent is 1×10-4 M.

TABLE 2
Kinetic parameters associated with the interconversion
of spiropyran and merocyanine in various solvents

| | μ | Λ | kUV | kDark | kVIS |
|---|---|---|---|---|---|
| Solvent | (10−2 D) | (nm) | (10−4 s−1) | (10−4 s−1) | (10−4 s−1) |
| DMF | 381 | 569 | 77 | 58 | 164 |
| MeCN | 390 | 561 | 131 | 107 | 172 |
| DCM | 114 | 577 | 189 | 259 | 306 |
| EtOAc | 177 | 584 | 400 | 362 | 380 |

All three constants (kUV, kDark, and kVIS) increase as the μ of the solvent decreases. The coloration and decoloration constants in the polymer matrixes with low Tg are similar to those constants in solvents with high μ. The coloration rates (kUV, kDark and kVIS) of PnBMA, which has a relative low Tg of only 15° C., are comparable to the coloration rates of MeCN and DMF, which have a relatively high dipole moment μ greater than 3.8 D. For this reason, in certain aspects of the optical storage medium 100, this polymer matrix is used for the photochromic layer 110 illustrated in FIG. 2.

### Fluorescent Component

The optical storage medium 100 is not limited in the manner in which the fluorescent layer 120 is formed. For example, a fluorescent compound may be evaporated onto or spin-coated onto a substrate 122. The fluorescent component within the fluorescent layer 120 of the optical storage device 110 is not limited as to a particular fluorescent compound. However, in certain aspects of the optical storage medium 100, an excitation wavelength of the fluorescent compound is centered in a region that is not substantially absorbed by either the first form or the second form of the photochromic compound within the photochromic layer 110. Also, the emission wavelength of fluorescent compound is absorbed by the first form of the photochromic compound but not absorbed by the second form of the photochromic compound. Under these conditions, an exciting beam can travel substantially unaffected through the photochromic layer 110 to the fluorescent layer 120 and the emitted light from the fluorescent layer 120 can propagate through the photochromic layer 110 and back to the detector 150 only when the photochromic layer is in the colorless state. Although not limited in this manner, the fluorescent compound may include benzofurazan (FIG. 7A).

### Example

Similar to the procedures described with regard to the polychromic component, polymethylmethacrylate (PMMA) films containing this benzofurazan were spin-coated onto quartz slides to obtain a film having a thickness of about 1 μm. The fluorescent layer 120 was prepared from dichloromethane solutions of benzofurazan (0.2 mg mL-1) and PMMA (100 mg mL-1). Aliquots of this solution was spin-coated on quartz plates at 1000 rpm for 5 seconds.

Referring to FIG. 7B, excitation (a) and emission (b) spectra of a PMMA film containing benzofurazan and absorption spectra of a PnBMA film doped with spiropyran before (c) and after (d) irradiation at 341 nm (4 μW cm-2) for 10 minutes are shown. The excitation band (a) of benzofurazan is centered at a wavelength of 450 nm, where neither spiropyran (c) nor merocyanine (d) absorbs, whereas the emission band (b) of benzofurazan is centered at 536 nm, where only merocyanine (d) absorbs. In this manner, a PMMA fluorescent layer 120 containing benzofurazan can be paired with any of the photochromic layers 110 doped with spiropyran to form the optical storage medium 100 shown in FIG. 2.

### Fluorescence Modulation Example

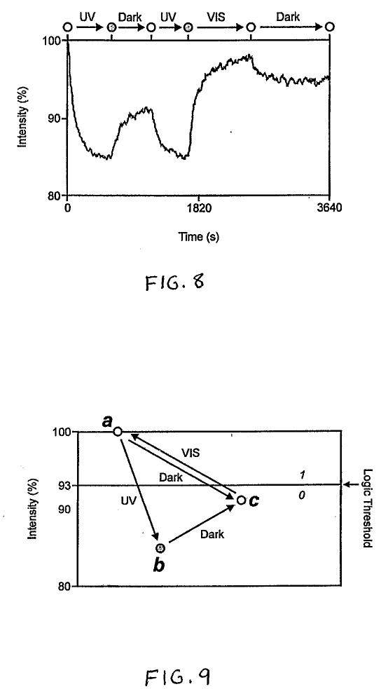

FIG. 8 illustrates changes in fluorescence intensity for the optical storage medium 100 of FIG. 2 upon irradiation at 341 nm (5 μW cm-2) or 562 nm (200 μW cm-2) and storage in the dark. The optical storage medium 100 was excited at 450 m and the fluorescence was monitored at 536 nm. The detected intensity dropped from 100% to 85% upon irradiation of the optical storage medium 100 at 341 nm (i.e., ultraviolet) by the second light source 140, in which the colorless spiropyran (i.e., the second form) isomerizes to the colored merocyanine (i.e., the first form). The photogenerated first form of the compound in the photochromic layer 110 absorbs and blocks a fraction of the emitted light from the fluorescent layer 120 traveling to the detector 150.

The photostationary state (e.g., about 85%) is reached in about 360 seconds. When the second light source 140 is turned off, the colored merocyanine reverts partially to the colorless merocyanine, and the detected intensity increases from 85 to 91% in about 520 seconds. The photostationary state is again reached in about 660 if the ultraviolet source is turned on again, as spiropyran switches back to merocyanine. In this manner, the intensity of the fluorescence output can be switched from high to low values by turning the ultraviolet input from off to on and vice-versa. In operation, binary digits can be encoded in the input (off=0, on=1) and output (low=0, high=1) under a positive logic convention, and output is 0 when the input is 1 and vice-versa. The detected emission intensity is high (binary 1) when the input is off (binary 0), and the detected emission intensity is low (binary 0) when the input is on (binary 1). The inverse relation between the input and output bits corresponds to a NOT function.

A change in irradiation wavelength from 341 nm (ultraviolet) to 562 nm (visible) switches the photochromic compound from one photostationary state to the other in about 830 seconds. The photoinduced re-isomerization from merocyanine to spiropyran results in an increase of detected intensity to 98%; and thus, the photoinduced fluorescence recovery is significantly more efficient than the corresponding thermal process, which is in full agreement with the absorbance changes observed for the photoinduced and thermal decoloration of the five polymers in Table 1. Only partial decoloration occurs in the dark (see FIG. 5B), whereas full decoloration is achieved under visible irradiation (see FIG. 5D).

If the visible source is turned off after reaching the photostationary state, a fraction of spiropyran isomerizes to merocyanine. Thermal equilibrium is reestablished, and the detected intensity drops to 94% in about 370 seconds. In this manner, the intensity of the fluorescence output can be switched from low to high values by turning the visible input from on to off and vice-versa. In this manner, the light emitted by the fluorescent layer 120 can be exploited to read the state of the photochromic layer 110. Additionally, the fluorescence reading does not alter the state of the photochromic switch.

Although merocyanine absorbs the light emitted by benzofurazan, the number of absorbed photons is not sufficiently high to significantly alter the ratio between spiropyran and merocyanine. The fluorescence trace for this step was constructed by reading the state of the system 210 times over an interval of 1260 seconds. As shown, the detected intensity decreases over time, which indicates an increase in the concentration of the absorbing state merocyanine. Despite the merocyanine having absorbed 210 times the fluorescence of benzofurazan, its concentration increases rather than decreases since the emitted light is too weak for the photoinduced decoloration to overcome the opposing thermal decoloration.

### Data Storage

The photoinduced changes in fluorescence intensity illustrated in FIG. 8 that are associated with the optical storage medium 100 of FIG. 2 can be used to store, retrieve and erase binary digits. FIG. 9 graphically illustrates a protocol for data storage and is a simplified version of the fluorescence trace illustrated in FIG. 8. In FIG. 9, only the three stationary values of the detected intensity are illustrated. Two of the stationary values correspond to the photostationary states reached after visible (a) and ultraviolet (b) irradiations. The third stationary value (c) corresponds to thermal equilibrium. A logic threshold may be set between the values associated with one of the photostationary states (a) and the other of the photostationary states (b) and thermal equilibrium (c).

Although not limited in this manner, a determination may be made that an intensity value above the logic threshold corresponds to a binary 1, and any intensity value below the logic threshold corresponds to a binary 0. For example, an ultraviolet input can switch the state of the system from 1 (a) to 0(b). If the input is turned off, the intensity increases. However, the intensity still remains below the logic threshold, even after reaching thermal equilibrium (c), which still corresponds to a binary 0. In this manner, the binary 0 written optically in the photochromic layer 110 is stored by the optical storage device 200.

The bit can be erased by illuminating the photochromic film 110 with a visible input. Under these conditions, the detected intensity raises above the logic threshold, and the bit is switched from a binary 0 back to binary 1. If the visible input is turned off after reaching the photostationary state (a), the detected intensity returns gradually to the value at thermal equilibrium (c), and it has been determined, using the above described configuration of materials, that it takes about 670 seconds to reach the logic threshold. Therefore, the binary 1 is stored only for a relatively short retention time. This limitation, however, can be overcome by replacing spiropyran within the photochromic layer 110 with a thermally-stable photochromic compound, for example, a diarylethene or a furylfulgide.

What is claimed is:

1. An optical storage medium having a multilayer structure, comprising:
a photochromic layer having a photochromic compound transformable between a first form and a second form; and
a fluorescent layer having a fluorescent compound having an emission wavelength that is substantially absorbed by the first form and not substantially absorbed by the second form.

2. The optical storage medium according to claim 1, wherein the fluorescent compound has an excitation wavelength that is not substantially absorbed by the second form of the photochromic compound.

3. The optical storage medium according to claim 2, wherein the excitation wavelength is not substantially absorbed by the first form of the photochromic compound.

4. The optical storage medium according to claim 1, wherein the first form is merocyanine and the second form is spiropyran.

5. The optical storage medium according to claim 1, wherein the fluorescent compound is benzofurazan.

6. The optical storage medium according to claim 1, wherein the photochromic compound is selected from the group consisting of azulenes, azobenzenes, stilbenes, fulgides, diarylethenes, and spiropyrans.

7. The optical storage medium according to claim 1, wherein the photochromic compound is thermally stable.

8. An optical storage medium having a multilayer structure, comprising:
a photochromic layer having a thermally-stable photochromic compound, wherein the photochromic compound is transformable between a first form and a second form; and
a fluorescent layer having a fluorescent compound, wherein the fluorescent compound has an excitation wavelength that is not substantially absorbed by the second form of the photochromic compound, and wherein the fluorescent compound has an emission wavelength that is substantially absorbed by the first form and not substantially absorbed by the second form.

9. An optical storage reading/recording device for reading/recording data on an optical storage medium, comprising:
a fluorescing light source emitting light having a first wavelength;
a transforming light source emitting light having a second wavelength; and
a detector sensitive to light having a third wavelength, whereby a fluorescent layer of the optical storage medium emits light having the third wavelength upon exposure to the first wavelength, and
a photochromic layer of the optical storage medium including a photochromic compound transformable between a first form and a second form upon exposure to light having the second wavelength.

10. The optical storage reading/recording device according to claim 9, further comprising a second transforming light source emitting light having a fourth wavelength, wherein the photochromic compound is transformable between the first form and the second form upon exposure to light having the fourth wavelength.

11. The optical storage reading/recording device according to claim 9, wherein the fluorescent layer has an excitation wavelength that is not substantially absorbed by the second form of the photochromic compound.

12. The optical storage reading/recording device according to claim 11, wherein the excitation wavelength is not substantially absorbed by the first form of the photochromic compound.

13. The optical storage reading/recording device according to claim 9, wherein the first form is merocyanine and the second form is spiropyran.

14. The optical storage reading/recording device according to claim 9, wherein the fluorescent compound is benzofurazan.

15. The optical storage reading/recording device according to claim 9, wherein the photochromic compound is selected from the group consisting of azulenes, azobenzenes, stilbenes, fulgides, diarylethenes, and spiropyrans.

16. The optical storage reading/recording device according to claim 9, wherein the photochromic compound is thermally stable.
